(19) United States
(12) Patent Application Publication
(10) Pub. No.: US 2005/0172496 A1
(43) Pub. Date: Aug. 11, 2005

(54) Gigantic strength type cutter knife

(76) Inventor: Min Zheng Zeng, Nantou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/772,440

(22) Filed: Feb. 6, 2004

(51) Int. Cl. B26B 3/06

(52) U.S. Cl. 30/151; 30/162

(57) ABSTRACT

A gigantic strength type cutter knife includes a knife body has a handle portion, a plurality of blades and a handle shell. The plurality of blades are superimposed and disposed in the knife body. The knife body is provided with a pushing key, which can drive one of the blades to be bulged outside the knife body. The handle shell assembled on the handle portion. The handle shell can be assembled on or taken away from the handle portion or replaced with a new one, whereby the handle portion of the gigantic strength type cutter knife can provide enough friction effect to avoid slipping by means of the handle shell and the shape of the handle shell is further full of variety to meet the requirement of consumer.

### FIELD OF THE INVENTION

The present invention relates to a cutter knife, and more particularly to a gigantic strength type cutter knife which bears a bigger cutting force for cutting a wood plate or a thick object and has a handle portion and a handle shell assembled on the handle portion, such that the handle shell can be assembled on or taken away from the handle portion or replaced with a new one to meet the requirement of a maker or an user.

### BACKGROUND OF THE INVENTION

According to the field of carpentry, typically, it is not necessary that an object, such as a wooden decorative laminate, a strip, etc., is cut by a saw, but that the object is cut by a cutter knife. The object which is cut by the cutter knife is not general paper material, and therefore the cutter knife must be designed to bear a bigger cutting force.

The said cutter knife, such as a gigantic strength type cutter knife, mainly includes a knife body and a plurality of blades. The plurality of blades are superimposed together and disposed in the knife body. The knife body is provided with a pushing key, which can drive the blade to be bulged outside the knife body or to be moved back inside the knife body. When the blade is bulged outside the knife body, a user can hold a handle portion which is disposed at an end of the knife body and then use the cutter knife to cut.

The handle portion of the cutter knife which is hold by the user is provided with a handle shell which is integrated formed thereon. The handle shell is made of rubber material and provides more comfortable effect of holding during cutting operation, and therefore the handle shell is essential to use the cutter knife. However, the handle shell and the handle portion are integrated formed together, in other words, the handle shell is positioned on the handle portion by using another injection molding, and the handle shell cannot be replaced.

As the cutter knife is used long time, the handle shell will be worn or cracked, such that the user feel uncomfortable when holding the handle shell. Furthermore, the hand of the user may slip off the handle shell during cutting operation. To replace the handle shell is necessary, but the structure of the cutter knife which is disclosed in the prior art cannot be replaced.

In addition, when a consumer buys the cutter knife, the handle shell cannot be replaced if the model and color of the handle shell won't satisfy the consumer. Thus, it is difficult that the cutter knife which is disclosed in the prior art meets the requirement of the consumer.

Accordingly, there exists a need for a gigantic strength type cutter knife to solve the above-mentioned problems and disadvantages.

### SUMMARY OF THE INVENTION

It is an object of the present invention to provide a gigantic strength type cutter knife that has a handle portion provided with a handle shell which can be assembled on or taken away from the handle portion, whereby when the handle shell is worn, the handle shell can be replaced with a new one to keep enough friction effect to avoid slipping during cutting operation.

It is another object of the present invention to provide a gigantic strength type cutter knife that has a handle portion provided with a handle shell which can be assembled on the handle portion and replaced with a new one, such that the gigantic strength type knife body is further full of variety and meets the requirement of consumer

In order to achieve the foregoing objects, the present invention provides a gigantic strength type cutter knife for cutting a wood plate and a thick object including a knife body, a plurality of blades and a handle shell. The knife body has a handle portion formed at an end of the knife body, a blade outlet disposed at the other end of the knife body, and a pushing key disposed the upper surface of the knife body. The plurality of blades are superimposed and disposed in the knife body, and bulged outside or moved back inside the blade outlet by controlling the pushing key. The handle shell is assembled on the handle portion. The handle shell can be assembled on or taken away from the handle portion, whereby the shape of the handle shell is further full of variety.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded perspective view of a gigantic strength type cutter knife according to an embodiment of the present invention.

FIG. 2 is a perspective view of a gigantic strength type cutter knife according to an embodiment of the present invention.

FIG. 3 is an exploded perspective view of a gigantic strength type cutter knife according to another embodiment of the present invention.

FIG. 4 is a partially expanded sectional view of a gigantic strength type cutter knife according to another embodiment of the present invention.

### DESCRIPTION OF THE PREFERRED EMBODIMENTS

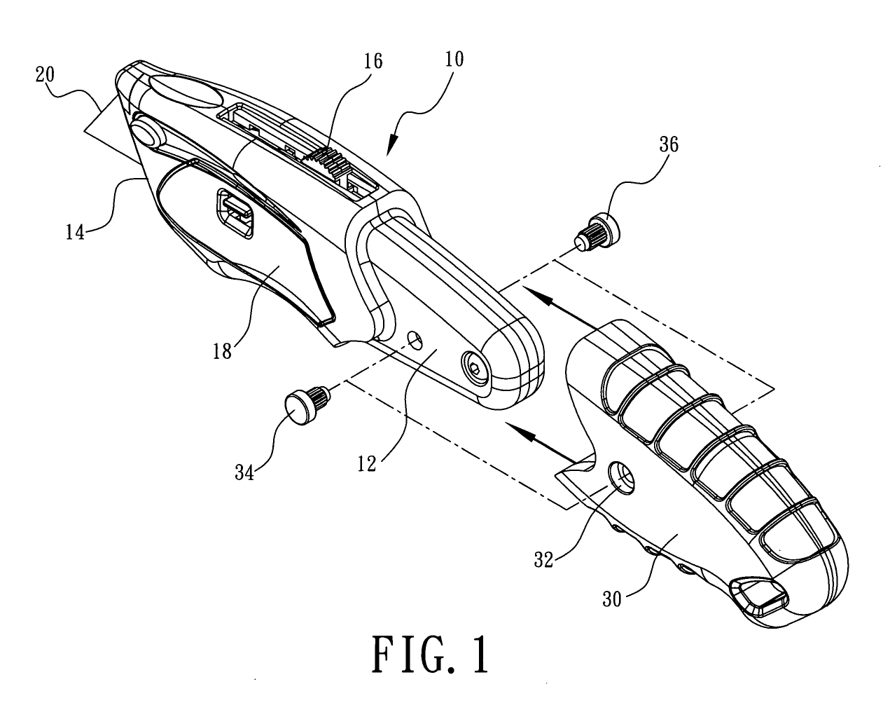

Referring to FIG. 1, a cutter knife disclosed in the present invention includes a knife body 10, a plurality of blades 20 and a handle shell 30. The knife body 10 is made of metal material. A handle portion 12 is formed at an end of the knife body 10, a blade outlet 14 is disposed at the other end of the knife body 10, and a pushing key 16 is disposed the upper surface of the knife body 10. Furthermore, the knife body 10 is provided with a receiving space (not shown) therein for receiving the plurality of blades 20. The receiving space and the blade outlet 14 are interlinked to each other, and the receiving space is provided with a cover 18 for covering or exposing the receiving space.

The plurality of blades 20are superimposed together and disposed in the knife body 10, and are bulged outside or moved back inside the blade outlet 14 by controlling the pushing key 16. The pushing key 16 can be moved forward or backward. When the pushing key 16 is pushed and moved forward in the direction of the blade outlet 14 of the knife body 10, one of the blades 20 will be pushed and bulged outside the blade outlet 14, so as to cut a thick object, such as a wood plate, wood decorative laminate, etc.

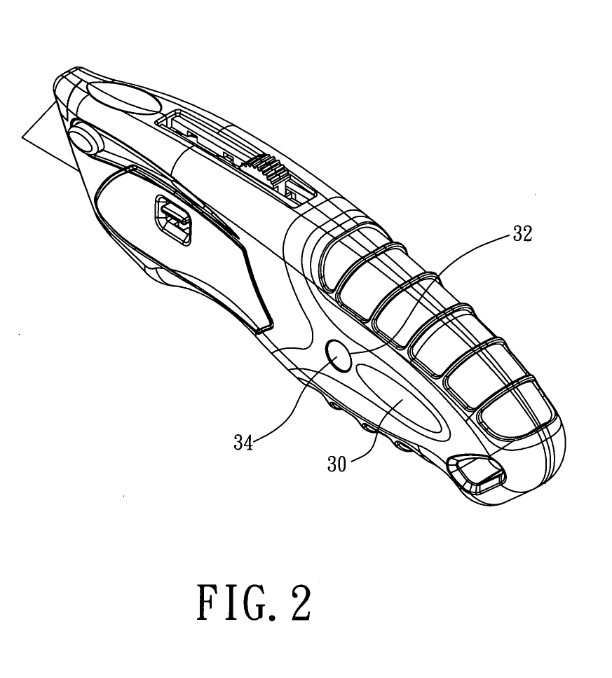

Referring to FIGS. 1 and 2, the handle shell 30 is made of plasticity material and a hollow shell component. There are rough and uneven veins in the surface of the handle shell 30 and providing friction, and there are two holes 32 are opposite to each other and disposed in two sides of the handle shell 30. The handle shell 30 is put around the handle portion 12, and a snapping element 34, such as a bolt, is penetrated through the holes 32 of the handle shell 30 and the handle portion 12. The snapping element 34 has an end which is snapped into a clasping end of another snapping element 36, such that the handle portion 12 and the handle shell 30 are assembled together.

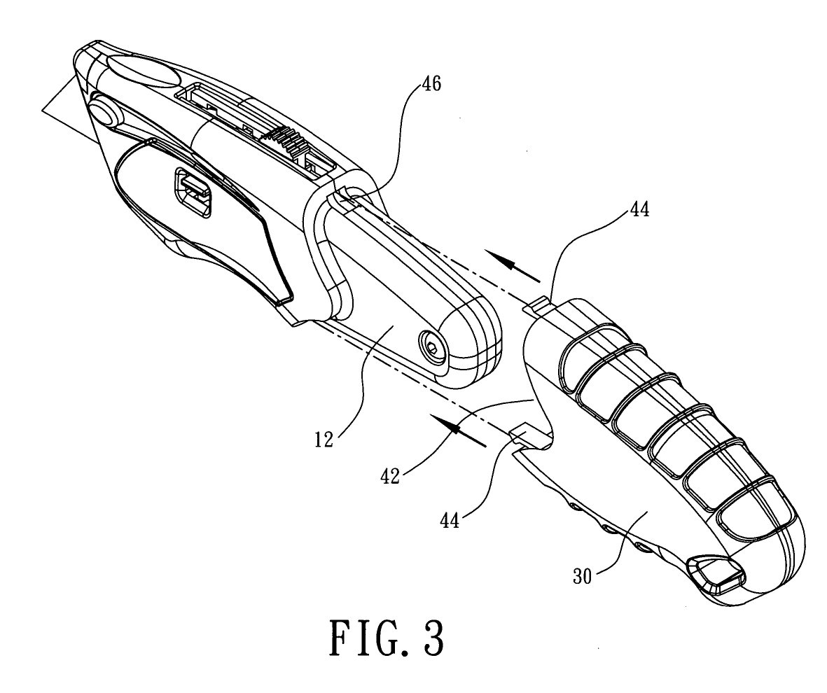

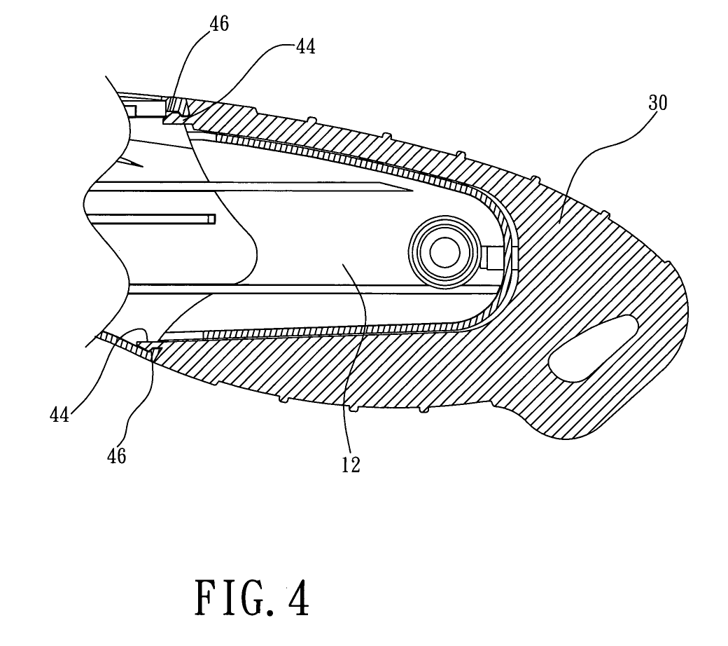

Referring to FIGS. 3 and 4, the handle shell 30 of the cutter knife according to another embodiment of the present invention has an opening 42 which is provided with a snapping protrusion 44 disposed at the edge thereof, and the handle portion 12 is provided with a snapping recess 46 disposed at the surrounding thereof. When the handle shell 30 is put around the handle portion 12, the snapping protrusion 44 can be snapped into the snapping recess 46, such that the handle portion 12 and the handle shell 30 are assembled together.

As described above, the handle shell 30 of the present invention can be taken away from the handle portion 12 and replaced with a new one by loosing the snapping elements 34, 36 or unfastening the snapping protrusion 44 and the snapping recess 46. Thus, when the rough and uneven veins which are disposed in the surface of the handle shell 30 cannot provide friction effect, a user can take away the handle shell 30 from the handle portion 12 and replace with a new one by means of the above-mentioned disassembling method, such that the handle shell 30 can keep enough friction effect to avoid slipping when the user uses the cutter knife.

Furthermore, when a user is not satisfied with the handle shell 30 which is assembled on the handle portion 12, the handle shell 30 can be replaced by means of the above-mentioned assembling method, such that the knife body is further full of variety and meets the requirement of consumer.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A gigantic strength type cutter knife for cutting a thick object, comprising:
a knife body having a handle portion formed at an end of the knife body, a blade outlet disposed at the other end of the knife body, and a pushing key disposed the upper surface of the knife body;
a plurality of blades superimposed and disposed in the knife body, and bulged outside or moved back inside the blade outlet by controlling the pushing key; and
a handle shell assembled on the handle portion;
wherein the handle shell can be assembled on or taken away from the handle portion, whereby the shape of the handle shell is further full of variety.

2. The gigantic strength type cutter knife according to claim 1, further comprising:
at least two holes disposed in two sides of the handle shell;
a bolt penetrated through the holes of the handle shell and the handle portion; and
at least one snapping element having a clasping end snapped into the bolt, such that the handle shell is assembled on the handle portion.

3. The gigantic strength type cutter knife according to claim 1, wherein the handle portion is provided with a snapping recess, and the handle shell is provided with a snapping protrusion which can be snapped into the snapping recess, such that the handle shell are assembled on the handle portion.
